(19) United States
(12) Patent Application Publication
(10) Pub. No.: US 2011/0266472 A1
(43) Pub. Date: Nov. 3, 2011

(54) Self piloted check valve

(76) Inventor: Larry Rayner Russell, Houston, TX (US)

(21) Appl. No.: 13/066,817

(22) Filed: Apr. 26, 2011

Related U.S. Application Data
(60) Provisional application No. 61/343,381, filed on Apr. 28, 2010.

(51) Int. Cl. F16K 31/12

(52) U.S. Cl. 251/28

(57) ABSTRACT

The present invention is a self piloted check valve which utilizes closure of a piloting flapper valve to permit development of closure forces for a ball valve. The normally open ball valve has a central flow passage and simultaneously rotates and translates as it traverses between its fully open and fully closed positions. An opening bias system utilizes a combination of a first strong, stiff spring and a second weaker, less stiff spring. Reversible decoupling means disconnects and reconnects the second spring at a short travel distance from the normally open position of the ball, while the first spring always provides opening bias forces to the ball. The pressure induced force required to fully close the ball valve following decoupling of the second spring is less than the force required to overcome the combination of the first and second springs.

### CROSS REFERENCE TO RELATED APPLICATIONS

The present application claims the benefit of the earlier filing date of provisional application Ser. No. 61/343,381 filed Apr. 28, 2011 entitled “Check Valve.”

### BACKGROUND OF THE INVENTION

1. Field of the Invention

The present invention relates in general to a method and apparatus for controlling fluid flow using a self piloted check valve. More particularly, the invention relates to a self piloted check valve which utilizes closure of a piloting flapper valve to permit development of closure forces for a ball valve.

2. Description of the Related Art

Conventional check valves are generally the least reliable type of valve. This is a consequence of flow for the open valve continually passing both the seat and the sealing plug of those check valves. This problem can lead to very rapid valve failure, particularly in abrasive flow applications or when larger objects pass by the valve. When conventional valves are used in high vibration abrasive situations, failures can occur with great rapidity. Additionally, such valves are sensitive to buildup of materials, such as paraffin, present in their flow streams. Significant buildups can prevent a valve from closing in low reverse flow conditions.

While the check valve covered by U.S. Pat. Nos. 4,220,176 and 4, 254,836. is exceptionally durable and can in general operate without maintenance for much longer periods than other types of check valve, improvements in vibration resistance are needed.

Improvements in vibration resistance are needed to avoid wear on the movable valve components resulting from their relative motion during vibration conditions. Such improvements are particularly needed when the valve is used with abrasive fluids, such as when the valve is employed in an oilfield drillstring near the bit.

Additionally, vibration resistance improvements are needed to render the check valve more suitable for service in applications in which films or other deposits are formed on the valve components from contact with liquids passing through the valve. Higher closure forces are often required to overcome resistance to closure from such films.

A further need for improvements to the original valve results from the need to ensure that it will move bidirectionally without interruption between its open and closed positions. Provision of this capability will enable the valve to minimize avoid fluid erosive wear and trash buildup during shifting of the valve position when reverse flows are weak.

A particular need exists for a choke and kill manifold check valve that will prevent excessive flows through the outlet pressure control system from uncontrolled well situations during drilling. Standard oilfield choke and kill manifold check valves typically are poppet check valves. Whenever the drilling operation stops for running wireline tools or other downhole operations, pumping ceases and the poppet of a conventional valve is removed. This is done to monitor well fluid volume changes during insertion and removal of the wireline equipment in the well bore.

Well volume changes in excess of those due to wireline displacement are indicative of well instability and possible blowouts. However, with the internals of the check valve removed, a critical safety component for the system is unable to be activated. This situation has previously resulted in well blowouts. There exists a need for a reliable, full time choke and kill manifold check valve which can permit the small amounts of reverse flow which occur during well wireline operations, but which will reliably close when reverse flows exceed a critical amount.

### SUMMARY OF THE INVENTION

Embodiments of the present invention include a full opening check valve responsive to flow utilizes a piloting normally closed flapper check valve to limit or prevent flow through the flow passage of a ball valve. When the ball valve is in its normally open condition abutting a travel limiting ball stop, its flow passage is coaxially aligned with the flow passage through its housing body and is spaced apart from the seat for the ball. When the ball is moved toward or away from its seat, it simultaneously rotates and translates. When closed, the hole through the closed ball is not aligned with the flow passage through its housing body and the ball sealingly engages with the seat.

The open ball is spring biased towards its open position by a combination of a first spring and a stiff strong second spring. When the ball moves a short distance toward its seat from its open position in response to reverse flow, the second spring is disengaged by a release mechanism after a short travel distance. This causes the resistance to ball closure to be reduced to a lower value for the remainder of the travel of the ball towards its seat. During flow responsive ball valve opening due to a flow response or spring biasing or both, the second spring is reengaged by the release mechanism as the ball nears its open position. As a consequence of the above described behavior, the normally flowing improved self-piloted check valve has less tendency to move in response to axial vibration. A tubular ball pusher transmits the opening spring bias forces to the ball.

An additional feature of the improved self piloted check valve is that reverse flow between the ball and its tubular ball pusher during valve closure is blocked by an annular seal on the ball end of the ball pusher tube transmitting the biasing forces to the ball until the second biasing spring is decoupled. This permits overcoming of increased closing resistance due to fluid deposit buildups.

One embodiment of the present invention is a self-piloted check valve with a main spring and a second biasing spring.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the structures for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a longitudinal section taken of the valve of the present invention housed in a tubular body suitable for connection into an oilfield drill string, whereby it can operate as an inside blowout preventer valve.

FIG. 2 shows a longitudinal section corresponding to FIG. 1, but showing only the internal component parts of the valve in its open, flowing condition. In this case, the ball is biased open by the action of two coacting, separate springs.

FIG. 3 shows a longitudinal sectional view corresponding to FIG. 2, but with the piloting flapper valve closed and the ball open. This view shows the valve in its normal position when flow has ceased, but there is no back pressure. In this position, the ball is still biased open by the action of two coacting, separate springs.

FIG. 4 is a longitudinal section corresponding to FIGS. 2 and 3, but showing the valve with the ball forced sufficiently upstream by back pressure from its position in FIG. 2 that the latch assembly with its secondary spring has just disengaged from the ball pusher. The ball pusher in this case continues to apply a reduced opening spring bias force from a single spring to the upstream side of the ball.

FIG. 5 is a longitudinal section corresponding to FIGS. 2, 3, and 4, but showing the ball fully seated in response to reverse flow so that reverse flow through the self piloted check valve is prevented.

FIG. 6 is an exploded oblique view of the ball cage assembly.

FIG. 7 is an exploded oblique view of the flapper and seat assembly.

FIG. 8 is an exploded oblique view of the latch assembly.

FIG. 9 is an exploded oblique coaxially aligned view of the flapper assembly and ball.

FIG. 10 is an exploded oblique view of the components used to retain the valve internals within the body of the inside blowout preventer body.

FIG. 11 is an axial view of the closed flapper and seat assembly for the inside blowout preventer version of the self piloted check valve.

FIG. 12 is an axial view of the closed flapper and seat assembly for the choke and kill manifold version of the self piloted check valve.

FIG. 13 is a longitudinal section view of a choke and kill check valve version of the present invention.

FIG. 14 is a longitudinal sectional view of a float valve version of the present invention.

FIG. 15 is a figure illustrating the valve opening bias force versus distance relationship.

FIG. 16 is a detail view taken within the circle 16 shown in FIG. 4. The view shows the relationship of the latch balls and their adjacent parts at the time that a disconnection or reconnection of the secondary spring biased trigger sleeve to the ball pusher occurs when the ball valve is respectively closing or reopening.

### DESCRIPTION OF THE PREFERRED EMBODIMENTS

The self piloted check valve of the present invention is generally suitable for high reliability applications where no rapid cycling of the valve, such as for inlet and outlet valves on a pump cylinder, is required. The materials of the valve typically are steel, with elastomeric seals sealing between parts as required. The flappers will be an abrasion resistant material such as Stellite 6. With only minor or no modifications, the basic internals of the improved self piloted check valve are suitable for use with several different housing body types, as described below in three examples.

Inside Blowout Preventer Valve

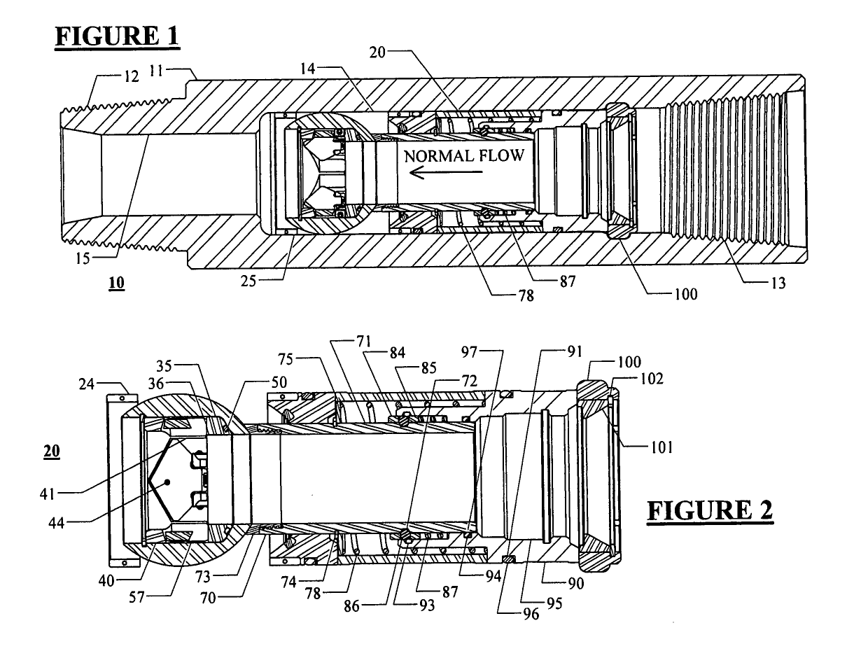

A first example of the self piloted check valve is an inside blowout preventer valve. Referring to FIG. 1, the self piloted check valve of the present invention is shown in a longitudinal sectional view as an inside blowout preventer 10, wherein its internal components are mounted in a body 11 suitable for interconnection into an oilfield drillstring. Provision is also made to use a split retention ring 100 and an interior support ring 101 with a snap ring 102 to retain the valve internal components in the body 11.

The exterior of the inside blowout preventer body 11 has a constant outer diameter over most of its length and a reduced diameter tapered male thread 12 at its first, lower end. Herein, the terms upper and lower refer respectively to the normal flow inlet direction and the normal flow outlet direction. Sequentially from its upper end, the body 11 has a tapered female thread 13, a straight main bore 14 interrupted by an axially short retention groove 16 near its upper end and having a transverse lower end, and a straight reduced diameter outlet bore 15 having a short downwardly increasing diameter tapered bore at its lower end. To avoid stress concentrations, an ample radius is used at the transition between the lower end of the main bore 14 and the outlet bore 15. The external corners of the short retention groove 16 are also radiused for the same reason.

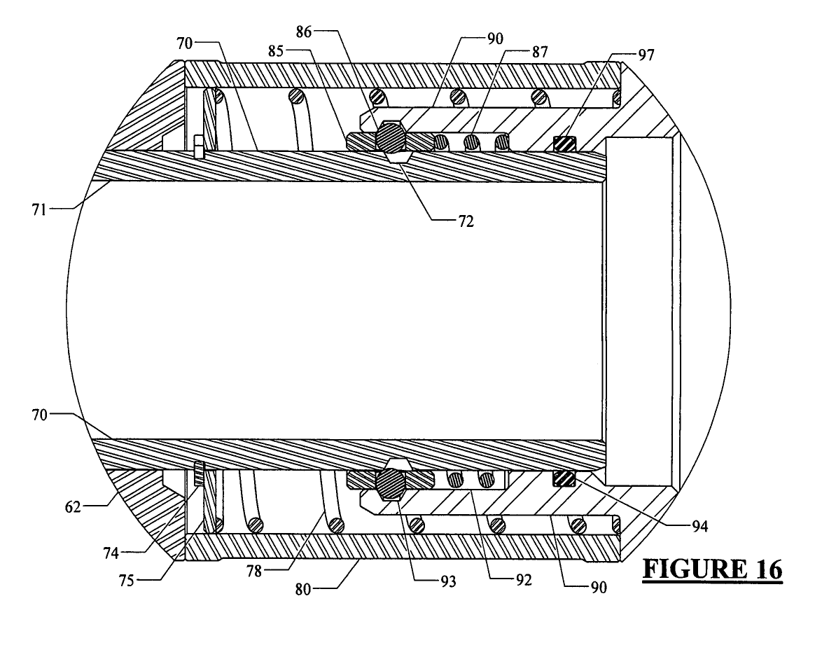

The primary internal components of the inside blowout preventer include a ball stop 21, a ball cage assembly 24, a ball assembly 33 including an internal flapper and seat assembly 34 and a main ball valve 62, a ball pusher assembly 70, a main spring 78 and spacer sleeve 80, a latch assembly 84, a spring retainer 90, and means 100, 101, and 102 to retain the valve internal components in the body 11 as seen in FIGS. 2 and 16.

Referring to FIG. 2, the internal components 20 of the valve 10 of FIG. 1 are shown removed from the inside blowout preventer body 10. At the lower, normal outflow end, the valve has a ball stop 21 with an integrally molded elastomeric ball stop 22 for cushing ball 53 impacts. The ball stop 21 is an axially short annular ring which, starting from its transverse lower end, has on its exterior a large taper, a short constant diameter section, a transverse upward facing shoulder, and a constant reduced diameter upward extension. The constant reduced diameter upward extension closely conforms to the inner diameter of the semicircular end arm 26 half rings on the ends of the ball cage assembly 24. The diameter of the short constant outer diameter section of the ball stop is a slip fit to the main bore 14 of the body 11 of the inside blowout preventer 10. The outer diameter is a close slip fit to the main bore 14 of the body 11.

From its lower interior end, the ball stop 21 has a small chamfer, a very short constant diameter minimum bore, a frustroconical upwardly increasing bore, a groove for containing a molded in ball stop bumper 22, and a spherical bore intersecting a narrow transverse upper end. The spherical bore of the ball stop 21 has the same diameter as that of the ball 53, so that the open ball 53 can abut the ball stop. The elastomeric molded in ball stop bumper 22 extends a short distance inwardly from the spherical bore of the ball stop 21 so that it cushions the contact of the ball 53 with the ball stop when the valve is opening.

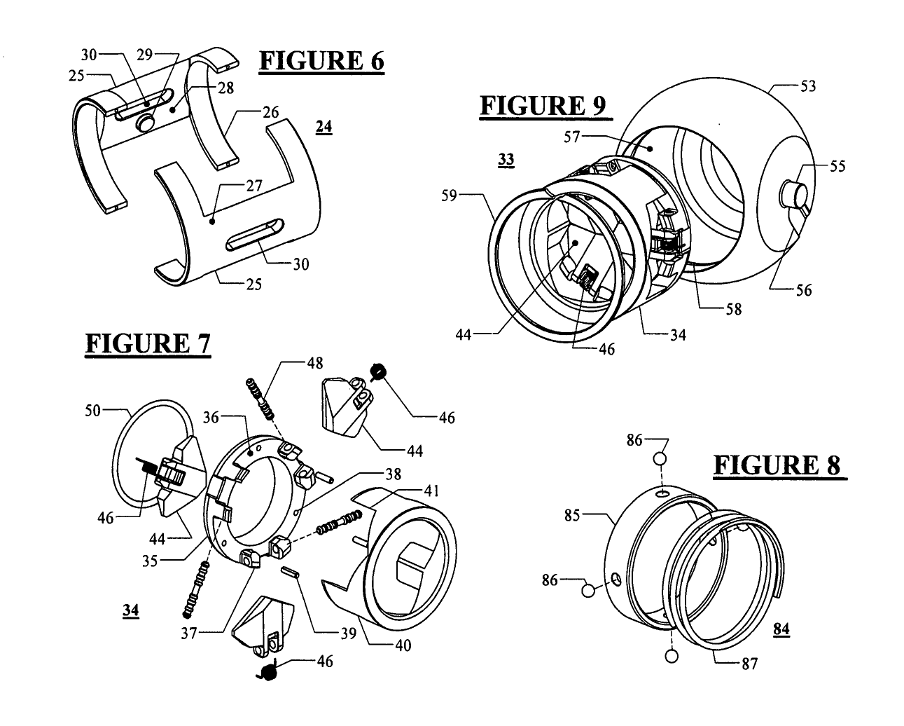

The ball cage assembly 24, shown in FIG. 6, consists of two opposed mirror image semicylindrical halves 25. Each ball cage half is symmetrical about its midplane perpendicular to the semicylindrical axis. At both its upper and lower ends, a ball cage half 25 has identical thin, axially short semicylindrical end arms 26 which have a constant rectangular cross section, wherein the radial thickness of the arm is approximately a quarter of the axial length of the arm. The outer diameter of the semicylindrical surface of the arms 26 is a close slip fit to the main bore 14 of the body 11 for the valve 10. The inner diameter of an arm 26 closely conforms to the constant reduced outer diameter portion of the lower ball stop 21, with which it is mated. The width of the arm 26 in the axial direction is the same as the length of the reduced constant outer diameter portion of the ball stop 21, and the upward looking intermediate transverse external shoulder of the ball stop abuts the lower side of the arm 26 of each installed ball cage half 25.

The middle portion of the ball cage half 25 has a cylindrical outer face 27 and a flat internal face 28 which mounts an inwardly extending cylindrical camming pin 29. The outer diameter of the middle section cylindrical surface 27 is the same as that of the semicircular end arms 26 and is also a close slip fit to the main bore 14 of the body 11 for the valve 10. The middle portion of the ball cage half 25 is symmetrically positioned between the end arms 26 so that the cylindrical external face 27 matches the outer diameter of the end arms 26. Also, the center of the middle portion of the ball cage half 24 matches the center of the arc of each of the semicircular end arms 26.

Symmetrically placed in the middle of the middle portion of each ball cage half 25 is a ball guide groove 30 parallel to the axis of the inside blowout preventer internal components 20. Groove 30 fully penetrates the middle section of the ball cage half 25. The groove 30 extends in the axial direction perpendicular to the flat internal face 28 and has semicircular ends with parallel flat sides. The inwardly extending cylindrical camming pin 29 is located at midlength of the ball cage half 25 and offset to one side of the ball guide groove 20.

The ball assembly 33 consists of a ball 53, a snap ring 59, and a flapper and seat assembly 34 which is mounted internally in the ball 53, as indicated in an exploded view in FIG. 9. The flapper and seat assembly 34 is shown in exploded view in FIG. 7. The flapper and seat assembly 34 primarily consists of a flapper seat ring 35, a flapper shroud 40, and three flappers 44. The flappers 44 are individually connected to trunnions 37 on the flapper seat ring 35 by flapper pivot pins 48 and are biased to be normally closed by torsional flapper springs 46.

The flapper seat ring 35 is a cylindrical ring having a transverse seating surface 36 and a right circular cylindrical coaxial through bore. The diameter of the through bore is the same as the through hole for the ball 53. On its exterior surface, a short right circular cylindrical surface adjoins the seating surface 36 and is joined by a generous fillet to a frustroconical end surface opposed to the seating surface 36. A male annular O-ring groove containing externally sealing O-ring 50 is positioned on the frustroconical face of the flapper seat ring 35.

Mounted on 120° spacings on seating surface 36 of the flapper seat ring 35 are three flapper support trunnions 37. Each flapper support trunnion 37 consists of a pair of mirror image spaced apart projections normal to the seating surface 36. The trunnions 37 each have a hinge bore parallel to the surface of the seating surface 36 and perpendicular to the midplane of that trunnion 37.

On the external cylindrical side of the flapper seat ring 35 between the trunnion 37 halves, flat bottom spring recesses parallel to the axis of symmetry of the ring are machined to provide clearance and support for the reaction arms of the torsional flapper bias springs 46. Equispaced on a circular pattern and symmetrically placed between each adjacent pair of trunnions 37 is a small diameter blind alignment pin hole 38 parallel to the axis of symmetry of the flapper seat ring and penetrating the seating surface. The alignment pins 39 are short roll pins which have an interference fit with the alignment pin holes 38.

The flapper shroud 40 is a right circular cylindrical annular ring having a length equal to about 80% of its outer diameter. The outer diameter of the flapper shroud 40 matches that of the flapper seat ring 35. As seen in FIGS. 7 and 9, the flapper recesses 41 are three radially penetrating identical windows located at 120° spacings in the flapper shroud. The recesses 41 are cut in the flapper shroud 40 from its first end to closely accommodate the open flappers 44 of the flapper and seat assembly 34. The flapper recesses 41 are symmetrical about their radial midplanes and have parallel sides extending approximately half of the axial length of the shroud 40. The inner end of each flapper recess 41 has converging opposed sides inclined at 60° from the radial midplane of the recess.

The first end of the flapper shroud 41 has three small diameter blind holes parallel to the part axis in the same pattern as the alignment pin holes 38 of the flapper seat ring 35 and with each hole located midway between adjacent flapper recesses 41. These holes have an interference fit with the alignment roll pins 39 of the flapper seat ring 35 and serve to permit the roll pins to firmly connect the shroud with the seat ring.

The flappers 44 are three identical abrasive resistant metal pieces made of a material such as Stellite 6. The flappers 44 have a planar sealing face on a first side and have a single plane of symmetry. A second planar face is opposed and parallel to the planar sealing face and extends in the direction of the plane of symmetry. The width of the second planar face is approximately 30% of the width of the flapper 44 perpendicular to its plane of symmetry. Outboard of the second planar face on each side, the thickness of the flappers 44 linearly tapers as a function of the distance from the second planar face.

Viewing a flapper 44 normal to its sealing face, two mirror image first planar faces, each normal to the sealing face, are each inclined at 60° from the plane of symmetry and extend to small planar outer ends parallel to the plane of symmetry. The first planar faces will adjoin corresponding faces of adjacent flappers 44 when they are assembled in their closed positions in the flapper and seat assembly 34, as shown in FIG. 11.

Short second planar faces inclined at 45° from the plane of symmetry and perpendicular to the sealing surface 36 extend inwardly from the small planar outer ends. Adjoining the second planar faces on the side towards the plane of symmetry are symmetrically placed short planar faces perpendicular to both the plane of symmetry and the sealing surface 36. These second planar faces on their inward ends are joined by third planar faces perpendicular to the sealing surface 36 and parallel to the plane of symmetry. The separation of the third planar faces is approximately the width of the second planar face which is opposed to the sealing surface 36.

On the third planar faces, through hinge holes are drilled at mid thickness of the flappers 44 and perpendicular to the midplane of symmetry. The outer end of a flapper 44 where its hinge holes are positioned is radiused about the axis of the hinge holes. A central gap extending inwardly in the direction of the plane of symmetry is cut between the third planar faces. This central gap is wide enough to accommodate a torsional flapper bias spring 46. The face opposed to the sealing face of the flapper 44 has a shallow central notch parallel to the sealing face and plane of symmetry and intersecting the central gap of the flapper 44. This shallow central notch provides a spring slot for a reaction point for a arm of the torsional flapper bias spring 46.

The flapper pivot pins 48 are elongated cylindrical rods with symmetrically placed molded narrow elastomeric rings on their outer ends. The flapper pivot pins 48 are engaged both in the hinge holes of the flappers 44 and in the trunnion 37 holes of the flapper seat ring 35. The elastomeric rings permit the flappers to seal with the seating face 36 of the flapper seat ring 35 in spite of small deviations in hole locations for the flappers 44 and the trunnions 37 of the flapper seat ring.

Referring to FIGS. 7 and 11, the flapper and seat assembly 34 is seen to have three flappers 44 mounted to the flapper seat ring 35 by flapper pivot pins 48. The torsional flapper springs 46, seen in FIG. 7, are located in the central gaps of the flappers surrounding the pins 48 with one arm of the spring bearing on the shallow slot of a flapper and the other on a spring slot on the outer diameter of the flapper seat ring 35.

To complete the flapper and seat assembly 34, an O-ring 50 is installed into the groove on the frustroconical face of the flapper seat ring 35 and the flapper shroud 40 is attached to the flapper seat ring by alignment roll pins 39. The closed flappers 44 have only a slight clearance between each other to prevent mutual interference. For this reason, the flappers 44 do not form a bubble tight seal when seated on the flapper seat ring 35.

The open flappers 44 also fit with only small clearance gaps into the flapper recesses 41 of the flapper shroud 40. The large planar sealing faces of the open flappers 44 open sufficiently to permit passage of a body having the same outer diameter as the bore through the flapper seat ring 35.

As seen in FIG. 9, the ball 53 has a spherical outer surface with two mirror image parallel flats on its exterior. The outer diameter of the spherical face of the ball 62 is only slightly less than the main bore 14 of the valve body 11. Each flat of the ball 53 has a central cylindrical guide pin 55 which is normal to its flat and is a close slip fit to a ball guide groove 30 of a ball cage half 25. The opposed guide pins 55 are located on a common ball diameter. Parallel to and centrally located between the opposed flats of the ball 53 is a through bore 57. From its large end, the through bore 57 has a long larger straight bore with a snap ring groove 58 near its outer end, an inwardly extending frustroconical face, and a shorter smaller straight fluid entry bore.

The smaller bore diameter for the ball 53 is the same as the central bore through the flapper seat ring 35. These two bore diameters determine the through clearance hole for the valve 10. A fillet connects the frustroconical face and the larger bore. The snap ring groove 58 accommodates snap ring 59 so that when the flapper and seat assembly 34 is inserted in the larger portion of the bore 57 of the ball 53 with the orientation shown in FIG. 9, it is retained with the O-ring 50 in the annular groove of the flapper seat ring sealing between the ball and the flapper seat ring 35.

A shallow camming groove 56 is cut in a radial direction of the face into each flat of the ball, with the opposed grooves being parallel and mirror images relative to the midplane of symmetry of the ball. The inner ends of the camming grooves 56 are radiused and spaced apart from the guide pins 55. The camming grooves 56 extend to the spherical surface of the ball 53. The orientation of the camming grooves 56 is such that the through bore 57 of the ball 53 is aligned with the valve axis when the ball is open and engaged in the ball cage assembly 24. When the valve 10 is closed by the ball, the longitudinal axis of the valve penetrates the spherical face of the ball 53 midway between the exits of the large exit hole and of the small exit hole of bore 57 of the ball on the plane of symmetry of the ball. This causes the axis of the camming grooves 56 to be inclined from the axis of the ball bore 57 by an angle of more than 45°.

The main seat 62 of the valve is an axially relatively short hollow cylinder having a transverse upper end with a smaller relieved transverse face on its interior side. The relieved face, which provides clearance for a snap ring 74 of the ball pusher assembly 70, is connected to the larger transverse end by a short frustroconical section. The bore of the main seat 62 is straight and somewhat larger than the smaller bore through the ball 53 in order to permit a slip fit of the lower exterior end of the ball pusher assembly 70.

The exterior cylindrical face of the main seat 62 has, from its upper end, a constant diameter first section extending about half of the axial length of the seat and with an intermediately placed male O-ring groove containing an O-ring 65 and a backup ring. The outer diameter of the first section of the exterior cylindrical face of the main seat 62 is a close slip fit to the main bore 14 of the body 11 of the valve 10. The O-ring 65 seals between the main seat 62 and the main bore 14 of the body 11.

On its lower end, the exterior cylindrical face of the main seat 62 has an inwardly extending transverse shoulder facing downwardly. A second section having a reduced diameter cylindrical section extends downwardly to a short inwardly extending transverse shoulder. The outer diameter of the second cylindrical section is a close fit to the inner cylindrical face of the semicircular end arms 26 of the ball cage halves 25, and the length of the second cylindrical section is the same as the axial length of a ball cage end arm 26.

On its lower end, the main seat 62 has on its interior side a spherical face 63 having the same diameter as the ball 53 and having an intermediate seal ring groove. The seal ring groove is undercut and contains a molded in elastomeric face seal 64 which extends radially inwardly from the spherical face 63 of the seat 62. However, the net volume of the molded in elastomeric face seal is less than the volume of the groove in the main seat 62 due to molded ridging of the exposed face of the seal 64. This permits the avoidance of seal damage when the ball 53 forcefully abuts the spherical face of the main seat 62.

When the inside blowout preventer internal components 20 of the valve 10 are being assembled, the ball assembly 33 with its ball 53 and flapper and seat assembly 34 is held between two opposed ball cage halves 25 so that its guide pins 55 are engaged in the ball guide grooves 30 of the ball cage assembly 24 and the camming pins 29 of the ball cage assembly are engaged with the camming grooves 56 of the ball.

The lower ball stop 21 is then engaged with the lower semicircular end arms 26 of the ball cage assembly 24 so that the side of the lower ball stop with the molded in ball stop bumper 22 is facing the ball. Following this, the main seat is engaged with the upper semicircular end arms 26 of the ball cage assembly so that the side of the main seat with the spherical face 63 is facing the ball.

The ball pusher assembly 70 consists of ball pusher body 71, a ball pusher seat 73, a snap ring 74, and a spring washer 75. The ball pusher body 71 is an elongated thin wall right circular cylindrical tube having a transverse external annular latch groove 72 located at about 30% of the length of the ball pusher body from its upper end. Additionally, an external snap ring groove mounting snap ring 74 is located at about 60% of the length of the ball pusher body 71 from its upper end. The bore of the ball pusher body 71 is the same as the smaller bore through the ball 53. The latch groove 72 is relative shallow and narrow, with frustroconical radially outwardly opening faces inclined at approximately 60° from the axis of the ball pusher body 71 joining it to the outer diameter portion of the ball pusher body 71.

At its lower end, the ball pusher body 71 has a female thread which is threadedly engaged with the male thread of a ball pusher seat 73. The ball pusher seat 73 is axially short and has the same inner and outer diameters as the ball pusher body 71. The ball pusher seat 73 is fabricated from either an elastomer or a plastic polymer such as a glass filled polytetrafluoroethylene. The lower face of the ball pusher seat 73 has a concave frustroconical or spherical face which is able to sealingly bear on the spherical face of the ball 53. At its upper end, the ball pusher seat 73 has a reduced diameter male thread comatable with the female thread on the ball pusher body 71.

The spring washer 75 is a relatively thin cylindrical flat washer with a central hole which is a slip fit to the outer diameter of the ball pusher body 71. The outer diameter of the spring washer 75 is slightly less than that of the spacer sleeve 80. The spring washer 75 is located on the upper side of the mounted snap ring 74 and bears against the snap ring. In turn, the lower end of the helical main spring 78 bears against the upper side of the spring washer 75 and when the spring is compressed urges the ball pusher assembly 70 downwardly so that the ball pusher seat 73 remains in contact with the ball 53. The upper end of the main spring 78 bears against a downwardly facing transverse shoulder of the spring retainer 90.

The spacer sleeve 80 is a thin wall right circular cylindrical sleeve with transverse ends and the central portion of its outer diameter slightly relieved. The outer diameter of the spacer sleeve is a slip fit to the main bore 14 of the body 11 of the valve 10. The inner diameter of the spacer sleeve 80 is a loose slip fit to the outer diameter of the spring washer 75. The outer diameter of the main spring 78 has sufficient clearance with the bore of the spacer sleeve 80, even when the main spring is fully compressed. The spacer sleeve 80 has a length equal to about 75% of its outer diameter and abuts against both the upper end of the main seat 62 and the larger diameter lower transverse face of the spring retainer 90.

The latch assembly 84, shown in FIG. 16, consists of a short thin wall right circular cylindrical latch sleeve 85, multiple latch balls 86, and a secondary spring 87. The inner diameter of the latch sleeve 85 is a slip fit to the outer diameter of the ball pusher body 71. The latch sleeve 85 is provided with multiple equispaced radial holes in a transverse plane located at midlength of the sleeve. The radial holes are close fits to the latch balls 86.

The radial wall of the latch sleeve 85 is approximately 60% of the diameter of the latch balls 86. When the radial holes of the latch sleeve 85 are positioned to be coplanar with the middle of the annular latch groove 72 of the ball pusher body 71, the latch balls 86 positioned in the radial holes and abutting the minimum diameter portion of the latch groove 72 do not extend beyond the outer diameter of the latch sleeve 85.

The secondary spring 87 of the latch assembly 84 is a stiff short helical spring with an inner diameter slightly larger than the outer diameter of the ball pusher body 71 and an outer diameter slightly smaller than that of the latch sleeve 85. The secondary spring 87 is mounted coaxially with the spring retainer 90 and the latch sleeve 85 of the latch assembly 84. The secondary spring 87 bears against the upper end of the latch sleeve 85 and a downwardly facing transverse end of a downwardly opening interior secondary spring recess 92 of the spring retainer 90.

The spring rate of the secondary spring 87 is appreciably higher than that of the main spring 78, and the maximum axial force applied to the ball pusher assembly 70 by the secondary spring 87 is greater than the maximum force ever applied to the spring washer 75 of the ball pusher by the main spring 78. The force from the secondary spring 87 acts on the latch sleeve 85 and also the ball pusher assembly 70 as long as the latch sleeve is engaged with the ball pusher assembly by the latch balls 86. The releasable interconnection which permits axial loads to be transferred from the radial holes of the latch sleeve 85 to the annular latch groove 72 of the ball pusher body 71 is provided by the radially reciprocable latch balls 86.

The spring retainer 90 is a right circular cylindrical sleeve with a length slightly longer than its outer diameter. From its upper end, the spring retainer 90 has on its exterior side a first cylindrical section which has an outer diameter which is a close slip fit to the main bore 14 of the body 11 of the valve 10. This first section has a length equal to approximately half of the total length of the spring retainer and contains a male O-ring groove 91 mounting an O-ring 96 and backup ring which provide sealing between the spring retainer 90 and the main bore 14 of the valve body 11.

An inwardly extending downwardly facing intermediate transverse shoulder on the lower end of the first cylindrical section connects to a reduced diameter second external cylindrical section which extends to the lower end of the spring retainer 90. The outer diameter of the second external cylindrical section is such that it provides clearance to the inner diameter of the main spring 78. The intermediate downwardly facing shoulder abuts both the upper end of the main spring 78 and the upper end of the spacer sleeve 80. A chamfer joins the lower end of the second external cylindrical section to a narrow downwardly facing transverse end.

From its lower end, the bore of the spring retainer 90 has a first counterbore with a transverse inner end serving as a secondary spring recess 92 and containing an intermediate female annular latch groove 93. The annular latch groove 93 has a short central enlarged constant diameter section with radially inwardly opening chamfers at its upper and lower ends extending to the counterbore for the secondary spring recess 92. The angle of the chamfers from the axis of the spring retainer 90 is approximately 60°.

The depth of the annular latch groove 93 is such that, when a latch ball 86 is positioned in the groove at its maximum radially outward position, the innermost portion of the ball will clear the outer diameter of the ball pusher assembly 70. The diameter of the counterbore of the secondary spring recess 92 is a close slip fit to the outer diameter of the latch sleeve 85. The length of the secondary spring recess is sufficiently long to fully contain the installed secondary spring 85 and most of the length of the latch sleeve 85 when the secondary spring 87 is fully compressed.

Adjoining the secondary spring recess 92 at its upper end is a short straight bore which contains an intermediate female O-ring groove 94 mounting internal O-ring 97. The diameter of this bore is such that it has a close slip fit with the outer diameter of the ball pusher body 71. The O-ring 97 seals between the spring retainer 90 and the ball pusher assembly 70.

At the upper end of the short straight bore with O-ring groove 94, a complex counterbore provides a landing profile for a lock-open tool which is not described herein. This concave profile varies, depending upon the type of lock-open tool to be used with the valve. Upwardly sequentially from the lower end of profile 95 are located an outwardly opening chamfer, a first profile counterbore, another upwardly opening chamfer, a larger second profile counterbore, a narrow female groove, and a short inwardly extending shoulder which has a counterbore smaller than that of the second counterbore. The inwardly extending shoulder and the female groove of the landing profile 95 permit the extraction, using a puller device, of the spring retainer 90 from the main bore 14 of the body 11 of the valve 10 during valve disassembly.

Adjoining the landing profile 95 at its upward end is a short upwardly opening frustroconical larger diameter counterbore and the upper transverse shoulder of the spring retainer 90. This last counterbore provides a recess so that a puller device can be used to extract the interior support ring 101 during valve disassembly. For the assembled valve 10, the upper transverse face of the spring retainer 90 is adjacent to the lower end of the latch groove 16 of the body 11 of the valve.

The inside blowout preventer internals 20 of the valve 10 are retained within the body 11 of the valve by the combination of the installed split retention ring 100, the solid interior support ring, and the male snap ring 102. Referring to FIG. 10, these components can be seen in an exploded view. The split retention ring has a cross section with a straight interior bore having near its upper end a female snap ring groove for the mounting of snap ring 102. The lower transverse end of the cross section of the split retention ring 100 is joined to the right circular cylindrical external side by a liberally radiused corner.

Near its upper end, the cross section of the external cylindrical side of the split retention ring 100 has a short reduced diameter section, with a radiused upper corner serving as the transition to the reduced diameter section. The radius of both corners is the same. The outer diameter of the split retention ring is a close fit to the diameter of the groove 16 of the body 11. The outer diameter of the reduced diameter section at the upper end of the ring 100 is a slip fit to the main bore of the body 11 of the valve 10. The length of the larger diameter portion of the split retention ring 100 is equal to or slightly less than the axial length of the latch groove 16 of the valve body 11.

As seen in FIG. 10, the split retention ring 100 is separated into four parts by two parallel cuts made parallel to but equally offset to opposite sides from the axis of symmetry of the part. The length of the longer segments of the ring 100 is less than the diameter of the main bore 14 of the body 11 of the valve 10. This permits the insertion of the diametrically opposed longer segments into groove 16 of the body 11 followed by the insertion of the shorter segments of the split ring 100. The upper transverse end of the spring retainer 90 of the other assembled valve internals 20 is abutted on its upper end by the downwardly facing transverse shoulder of the split retention ring 100.

The interior support ring 101 has an outer diameter which is a close slip fit to the straight interior bore of the installed split retention ring 100. The length of the interior support ring 101 is just slightly less than the distance from the lower transverse end to the lower side of the female retaining ring groove of the split retention ring 100. The interior support ring 101 has two opposed narrow transverse ends. The interior side of the interior support ring has from its upper end a frustroconical converging counterbore, a downwardly facing transverse shoulder, and a downwardly facing short counterbore engagable by a puller tool so that the ring can readily be extracted during valve 10 disassembly.

When the interior support ring 101 is inserted within the bore of the assembled split retention ring 100, the split retention ring is trapped within the groove 16 of the body 11 of the valve 10. In this position, the split retention ring abuts the upper end of the spring retainer 90 so that the internal components 20 of the inside blowout preventer are maintained in position within the body 11 of the valve. This is the case even when the valve 10 is resisting high pressures from reverse flow tendencies acting on its ball 53. Insertion of the snap ring 102 into the female snap ring groove of the split retention ring retains the interior support ring 101 within the bore of the split retention ring, but readily permits selective disassembly and removal of the rings 100, 101 so that the valve internals 20 can be removed.

Choke and Kill Manifold Check Valve

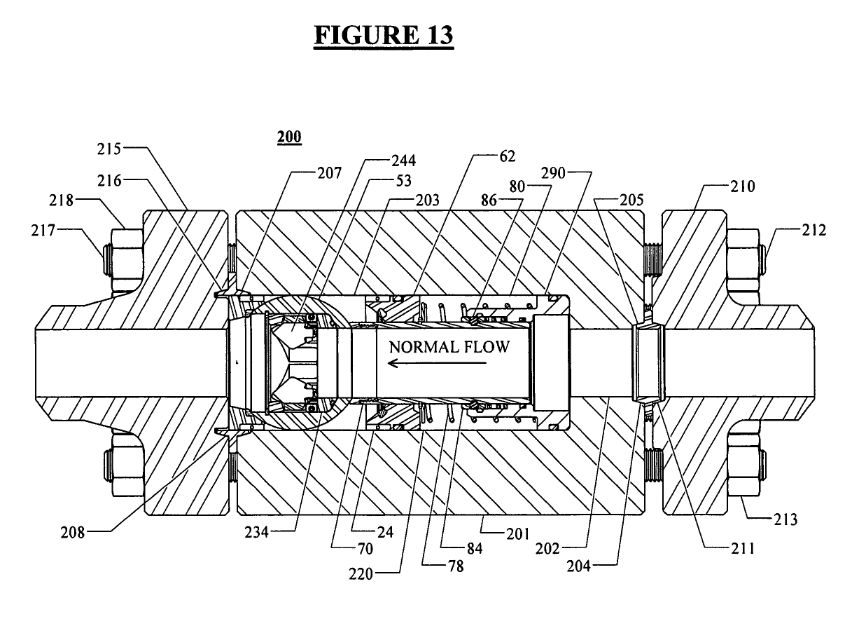

FIG. 13 shows a longitudinal sectional view of the self piloted check valve mounted in a body arrangement having weld neck flanges suitable for connection into an oilfield drilling choke and kill piping system. This choke and kill valve 200 has internal components which are functionally the same as those of the inside blowout preventer valve 10 with the exception of the flappers of the flapper and seat assembly 34.

In the case of the flappers, the structural change is minor and produces only a slightly exaggerated behavior which is exhibited to some degree for all versions of the valve. Most of the internal parts of the choke and kill manifold check valve 200 are structurally identical to those of the inside blowout preventer 10. Other than the changes to the flappers 244, minor changes to some parts are necessitated for mounting the valve internals in a different type of body, but both those parts and the choke and kill manifold valve 200 function in substantially the same manner as the inside blowout preventer 10.

Referring to FIG. 13, the choke and kill valve body 201 is a right circular cylindrical body with a constant outer diameter equal to approximately 65 percent of its length. At its first end, the body 201 has a short fluid entry bore 202 which has a diameter equal to that of the valve internals 220. The main bore 203 enters from the end opposed to the end with the fluid entry bore 202 and has a diameter which is a close slip fit to the choke and kill valve internal components 220. The length of the main bore 203 is such that the valve internals 220 can be fitted into the bore both with allowance for fabrication tolerances and without interfering with mounting of the large seal 208 and the large flange 215.

Both ends of the choke and kill valve body 201 are provided with regular arrays of drilled and tapped holes for engagement by flange bolting. On its outer end the fluid entry bore 202 has a short inwardly converging frustroconical small seal recess 204 which mounts a commercially available small diameter metallic seal 205. The annular small metallic seal has a thin central flange on its outer side with a straight through bore equal to that of the short fluid entry bore 202. The seal 205 has mirror image seal surfaces which externally radially inwardly taper with distance from the central flange. The tapered seal surfaces seal with an interference fit with the small seal recessers 204 and 211 when the seal flange is clamped between the body 201 and the small flange 210.

On its outer end the main bore 203 has a short inwardly converging frustroconical large seal recess 207 which mounts a large diameter metallic seal 208. The annular large diameter metallic seal 208 has the same type of construction and operation as that of the small metallic seal 205, with the only difference being related to seal size. The tapered large seal surfaces seal with an interference fit with the large seal recesses 207 and 216 when the seal flange is clamped between the body 201 and the large flange 210.

The small flange 210 is a typical bolted weld neck flange, but it has a seal groove appropriate for use with seal 205. The outer diameter of the small flange 210 is the same as that of the body 201 and its through bore is the same as that of the valve internals 220. Flange 210 has a regularly spaced pattern of bolt holes offset from its axis of symmetry corresponding to those on the inlet end of the body 201 and a cylindrical weld neck that extends outwardly on the back side of the flange. On the entry to the through bore on the side facing the valve body 201, the flange 210 has a small seal recess 211 identical to the small seal recess 204 of the body. Studs 212 and nuts 213 are used to clamp the small flange 210 to the body 201 and to energize the seal 205.

The large flange 215 also is a typical bolted weld neck flange, but thicker and with a larger bolt circle diameter than the small flange 210. The outer diameter of the large flange 215 is the same as that of the body 201 and its through bore is the same as that of the valve internals 220. Flange 215 has a regularly spaced pattern of bolt holes corresponding to those at the exit of the main bore 203 of the body 201. On its axis of symmetry, the large flange 215 has a cylindrical weld neck which extends outwardly on the back side of the flange. On the entry to the through bore on the side facing the valve body 201, the flange 215 has a large seal recess 216 identical to the large seal recess 207 of the body. Studs 217 and nuts 218 are used to clamp the large flange 215 to the body 201 and to energize the seal 208.

As shown herein, the seal groove diameter for mounting the small flange 210 is smaller than that for the large flange 215, although the groove and flange for the fluid entry bore end could alternatively be made identical with that for the fluid exit end of the valve 200.

The choke and kill valve internal components 220 include a choke and kill valve ball stop 221, a choke and kill flapper assembly 234 with a flapper 244, and a choke and kill spring retainer 290 that differ slightly structurally but not functionally from the corresponding components of the inside blowout preventer 10. The other choke and kill valve internal components 220 are the same, with the exception that the split retention ring 100, the interior support ring 101, and the snap ring 102 are omitted. These omitted parts are not required because the large flange 215 serves to retain the valve internal components 220 in the valve body 201.

Referring to FIG. 13, the choke and kill ball stop 221 with a molded in ball stop bumper does not need the large chamfer on its external flow outlet corner that the inside blowout preventer ball stop 21 requires to fit in body 11. That corner for the choke and kill ball stop 221 is only lightly chamfered, and the axial length of the ball stop 221 is slightly reduced from that of ball stop 21 for the inside blowout preventer in order to limit the overall length of the valve. Otherwise, the ball stop 221 and its molded in bumper are structurally and functionally identical to the lower ball stop 21 of the inside blowout preventer 10.

For the choke and kill manifold valve 200, the ball cage assembly 24, ball 53, and main seat 62 are the same as for the inside blowout preventer 10 and are assembled with the same relationships. The ball stop 221 and the main seat 62 support the opposed halves 25 of the ball cage assembly 24. The ball 53 has its guide pins engaged in the ball guide groove 30 of the ball cage assembly 24 as before. The caroming grooves 56 of the ball 53 are engaged by the caroming pins 29 of the ball cage halves 25 in the same manner as for the inside blowout preventer 10.

The flapper and seat assembly 234 of the valve 200 is identical to the corresponding assembly 34 for the inside blowout preventer except for use of flappers 244 for valve 200. Referring to FIGS. 11 and 12, the flapper and seat assemblies 34 of the inside blowout preventer 10 and 234 of the valve 200 are respectively shown in axial views seen from their outlet sides.

Only small clearance gaps sufficient for operating clearances between adjacent flapper 44 faces are provided for the inside blowout preventer 10 flapper and seat assembly 34 shown in FIG. 11. However, since some limited backflow is desirable for the choke and kill manifold valve 200 in order to accommodate wireline operations with the valve functionally able to perform its reverse flow checking function for higher reverse flows, the gaps between adjacent flapper faces 244 are made larger to permit additional reverse flow, as seen in FIG. 12. The desired size of the gap for the flappers 244 can be determined readily by calculation.

The ball pusher assembly 70, the main spring 78, the spacer sleeve 80, and the latch assembly 84 are common to both the choke and kill check valve 200 and the inside blowout preventer 10 and function the same in both devices. The choke and kill spring retainer 290 is different from the spring retainer 90 for the inside blowout preventer valve 10 because no provision for lock open tools is required for valve 200. However, the bore on the inlet end of the spring retainer 290 is enlarged sufficiently to permit engagement with puller or pusher means (not shown) to forcibly extract the choke and kill valve internals 220 from the body 201 for servicing.

Drilling Float Valve

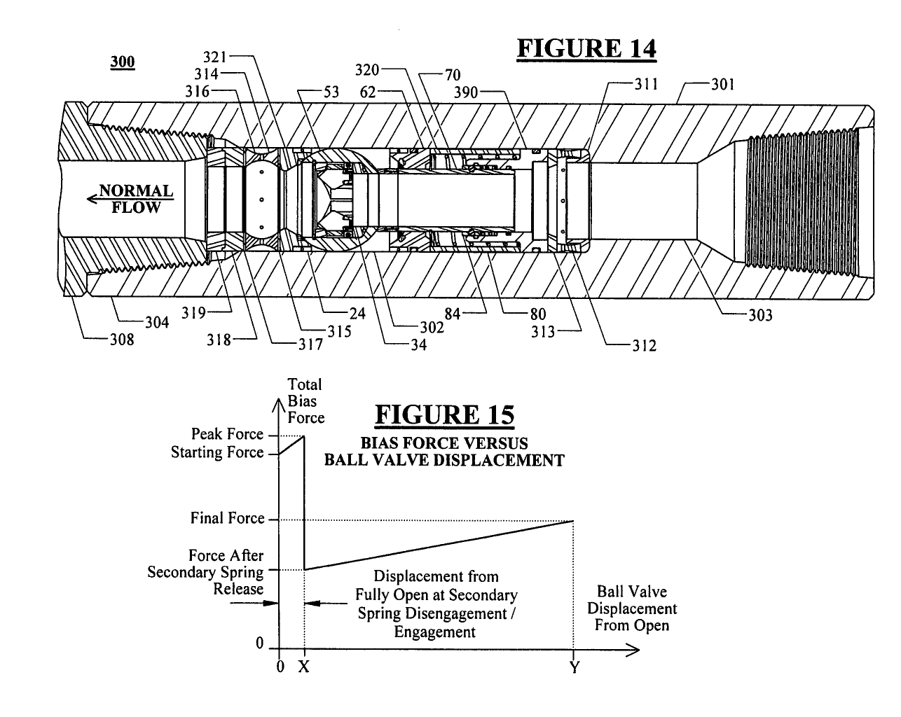

FIG. 14 shows a longitudinal sectional view of a drilling float valve 300 installed in a housing for mounting between a drill bit and the drill collars of a drill string. Drilling floats are routinely used to avoid backflows through the drillstring during the making of connections. The primary differences between float valves and inside blowout preventers are related to their bodies and provisions for the severe vibrational environment near the bit for float valves. Float valves are used routinely, rather than for emergencies, and are particularly important when the well is being drilled in an underbalanced condition.

For the float valve 300, the same improved self piloted check valve of the present invention can be used with internal components which are functionally the same as those of the inside blowout preventer valve 10. The body differs from those of the inside blowout preventer 10 and the choke and kill valve 200 for this float version of the valve. Most of the internal parts of the drilling float valve 300 are structurally identical to those of the inside blowout preventer 10. Minor changes to some internal parts are necessitated for mounting the valve internals in a different type of body, but both those parts and the valve 300 function in the same manner as for the inside blowout preventer 10. Some additional parts are required to ameliorate the high vibration problem for the float valve 300, but those parts do not affect the principles or manner of operation of the key valve components.

Referring to FIG. 14, the drilling float valve body 201 has a right circular cylindrical body with a constant outer diameter equal to approximately 25% of its length. At its transverse upper first end, the body 301 has a tapered female drill pipe thread so that it can be threadedly interconnected into a drill string. At the lower end of the upper thread, a frustroconical transition downwardly reducing in diameter connects to a straight fluid entry bore 302 which has a diameter equal to or greater than that of the float valve internal components 320. The length of the fluid entry bore 302 is between 50 percent to 100 percent of a body 301 diameter long. This length permits several recuts of the threads on the upper end of the body 301. At its lower fluid outlet end 304, the body 301 has a female drill pipe thread for connection with the threaded shank 308 of a drill bit.

At its lower end, the fluid inlet bore 303 terminates in a downwardly facing and radially outwardly extending internal transverse shoulder 305. The transverse shoulder 305 forms the upper end of the main bore 303 of the body 301. A large fillet joins the main bore 302 and the downwardly facing transverse shoulder 305. The main bore 302 has a diameter which is a close slip fit to the float valve internal components 320. The length of the main bore 302 is such that the valve internals 320 can be fitted into the bore along with upper 310 and lower 314 damper assemblies and axial space filler rings 317, 318 which might be required without interfering with the threaded make up of the a drill bit shank 308 into the female oilfield thread at the outlet lower end of the body 301.

The upper damper assembly 310 consists of an upper damper retainer ring 311, an upper damper elastomeric element 312, and an upper damper abutment ring 313. The outer diameter of the assembly 310 is a slip fit to the main bore 302 of the body 301. Typically, the ends of the elastomeric element 312 are bonded to the end rings 311, 313. The upper damper retainer ring 311 has a straight bore, a narrow transverse lower end, an upwardly extending external cylindrical face, a downwardly facing and outwardly extending transverse face, and a radiused shoulder connecting to a narrow transverse upper end.

The upper damper elastomeric element 312 is a cylinder which has equal transverse ends. The outer cylindrical face has a reduced diameter in its central portion, while the inner cylindrical face has an increased diameter in its central portion. Multiple equispaced radial holes penetrate through the middle portions of the elastomeric element 312. The upper damper abutment ring 313 has a right circular cylindrical outer face adjoined to two relatively narrow transverse ends. The bore through the ring 313 is frustroconical and opens upwardly.

The lower damper 314 is a cylindrical assembly of support rings and an elastomeric element which is symmetric about its transverse midplane. Mirror image thin flat annular rings serve as upper 315 and lower 317 support rings. The lower damper elastomeric element 316 is constructed similarly to the upper damper elastomeric element 312. The lower damper assembly 314 is a slip fit to the main bore 302 of the body 301.

Both the upper 312 and the lower 314 dampers are compressed when the valve internals 320 are retained in the body 301 by the drill bit shank 308. By supporting the valve internals between the elastomeric upper 310 and lower 315 dampers, the accelerations and resultant forces applied during drilling to the float valve internal components are reduced.

Because the body 301 of a float valve is subject to severe operating conditions, its end threads are frequently recut. First 318 and second 319 filler rings may be used to avoid the need to remachine the main bore 302 of the valve 300 whenever the threads at the lower end of the body 301 are recut. Each right circular cylindrical ring 318, 319 has a length equal to the length removed during a single thread recut. The first filler ring 318 has a downwardly extending annular outer ridge on its lower transverse face which closely comates with a corresponding outer annular groove on the upper transverse face of the second filler ring in order to maintain axial alignment of the rings. Both rings 218 and 319 are a close slip fit to the main bore 302 of the float valve body 301.

The float valve internal components 320 include a float valve lower ball stop 321 and a spring retainer 290 that differ structurally but not functionally from the corresponding components of the inside blowout preventer 10. The other float valve internal components 320 are the same as for the inside blowout preventer valve 10, with the exception that the split retention ring 100, the interior support ring 101, and the snap ring 102 are omitted. These omitted parts are not required because the shank 308 of the drill bit serves to retain the components 320 in the valve body 301.

The float valve internal components 320 include a lower ball stop 321, a ball cage assembly 24, a ball assembly with internal flapper and seat assembly 34, a ball 53, a main seat 62, a ball pusher assembly 70, a latch assembly 84 with latch balls 86, and a choke and kill spring retainer assembly. The spring retainer assembly 290 of the choke and kill valve 200 can also be used for the float valve 300. The size of the main bore 302 of the body 301 is selected to provide a close slip fit to the internal components 320 of the float valve 300. The close fit facilitates sealing with the main bore 302 as necessary.

Referring to FIG. 13, the float valve ball stop 321 with a molded in ball stop bumper 22 does not need the large chamfer on its external flow outlet corner that the inside blowout preventer ball stop 21 requires to fit in body 11. That corner for the float valve ball stop 321 is only lightly chamfered, and the axial length of the ball stop 321 is slightly reduced from that of ball stop 21 for the inside blowout preventer in order to limit the overall length of the valve. Otherwise, the ball stop 321 and its molded in bumper are structurally and functionally identical to the lower ball stop 21 of the inside blowout preventer 10.

The spring retainer assembly 290 from the choke and kill valve 200 has been selected so that its enlarged upper end bore can facilitate removal of the valve internal components 320 with a puller device. Also, the flat upper end of the spring retainer 290 provides good contact with the upper damper 310.

Operation of the Invention

The unidirectional flow control provided by the improved self piloted check valve of the present invention works substantially the same in all configurations 10, 200, and 300 disclosed herein. For these embodiments, this is the case in spite of its being housed in a variety of bodies and minor changes being made to valve components to accommodate those bodies and their service conditions. For simplicity, the description of valve operation will be limited to the first embodiment 10 of the improved self piloted check valve, since all embodiments work in the same manner.

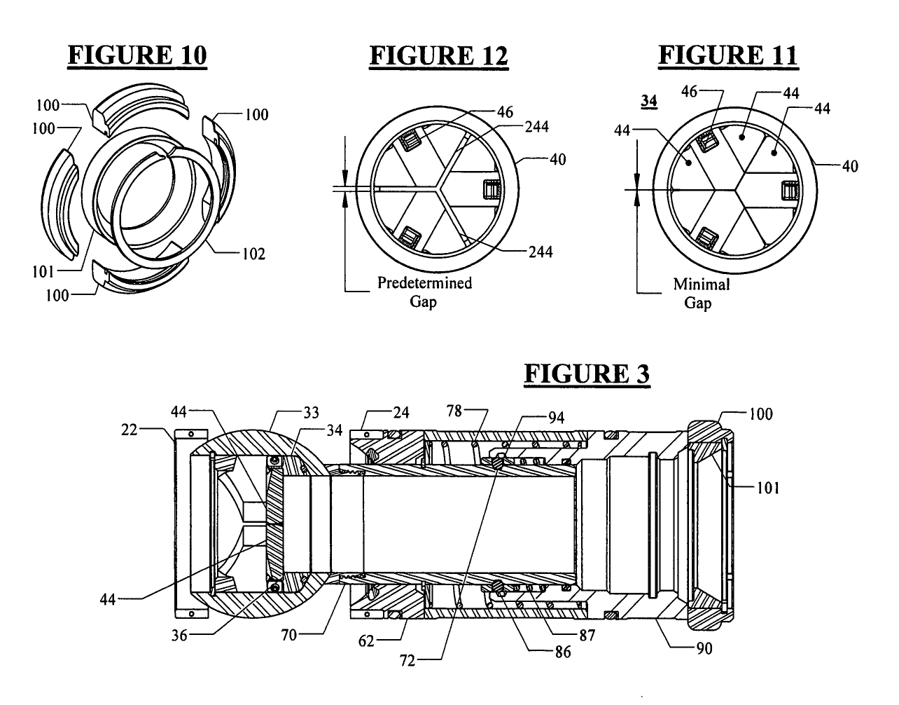

As seen in FIGS. 1, 2, 3, 4, 5 and 16, the improved self piloted check valve 10 disclosed herein uses a ball valve 53 with a central flow passage 57 to seal against reverse flow by blocking the cylindrical axial flow path through the body 11 and, excluding the piloting flapper valve assembly 34, the assemblage of other internal parts of the valve. As its means for preventing backflows, the valve 10 uses a ball 53 having a through flow passage 57 which is supported in a ball cage 24 so that it simultaneously translates axially on the longitudinal axis of the valve 10 and rotates about a ball axis transverse to the longitudinal axis of the valve 10. The ball 53 moves between a first open position with the ball flow path aligned with the valve 10 axis and a second closed position with the ball flow path out of alignment with the valve axis.

The ball 53 of the improved self piloted check valve 10 has two spaced apart opposed limits to its movements along the valve axis. Abutting the lower ball stop 21 as shown in FIGS. 1, 2, and 3 determines a first limit to ball 53 travel at its open position, while abutting the main seat 62 as seen in FIG. 5 determines a second limit to ball travel at its closed position.

The ball 53 is provided with a cylindrical internal through flow passage bore 57 which can permit flow when the ball 53 is in its first, open position with its bore 57 aligned with the valve 10 longitudinal axis. When the ball 53 is in its second, closed position, the flow passage bore 57 of the ball 53 is out of alignment with the longitudinal axis of the valve 10 and in engagement with the molded-in elastomeric seal 64 of the valve seat 62 against the spherical surface of the ball to block flow through the valve, as seen in FIG. 5.

The opposed ball flats parallel to and laterally offset from the flow passage 57 of the ball 53 mount central guide pins 55 which have axes that intersect the axis of the ball through bore 57 at right angles. These ball guide pins 55 and the flats of the ball 10 coact with the ball guide grooves 30 and flat internal faces 28 of the ball cage halves 25 to maintain the ball guide pin 55 axis perpendicular to and intersecting with the longitudinal axis of the valve 10.

The two mirror image ball camming grooves 56 are cut into the face of each opposed flat of the ball 53. These grooves 56 extend in the radial direction relative to the guide pins 55 on the flats of the ball 53. The axes of the camming pins 29 of the stationary ball cage halves 25 are laterally offset from the longitudinal axis of the valve 10 and are engaged with the camming grooves 56 of the ball 53.

When an axial force is applied to the ball 10, the ball tends to move along the valve axis. At the same time, the eccentric camming pins 29 abut the camming grooves 56 of the ball 53 to produce reaction forces on the sides of the ball grooves 56. The component acting parallel to the ball axis of these reactions on the sides of the ball grooves 56, together with the force tending to move the ball 53 along the valve axis, result in a force couple acting on the ball. This resultant force couple produces the simultaneous rotation of the ball 53 to accompany its axial movement.

A spring bias is used to urge the ball valve 53 to its normally open condition where it permits exiting flow through the valve 10, while separate torsional spring 46 biases are used to urge the piloting flapper valve 34 to its normally closed position. With the flapper and seat assembly 34 mounted in the annular recess in the through bore 57 of the ball 53, closure of the flappers 44 prevents or strongly restricts reverse flow through the ball. Likewise, the flappers 44 readily open in response to forces induced on them by exiting flows moving in the normal flow direction through the valve 10, thereby permitting exiting flow from the valve whenever the ball 53 is in its fully open position.

The opening spring bias for the ball valve 10 is provided by combining two separate springs 78 and 87 with different properties working in parallel. The main spring 78 is relatively weaker and less stiff than the secondary spring 87. A tubular ball pusher assembly 70 having a ball pusher seat 73 bears on the spherical surface of the bail valve 53 and transmits the forces of the opening spring biases to the ball. The biasing forces applied by the main spring 78 act on the ball pusher assembly 70 through the spring washer 75 and the snap ring 74.

Biasing forces from the secondary spring 87 react against the latch sleeve 85 of the latch assembly 84. The multiple small diameter balls 86 engaged in the radial holes through the latch sleeve 85 are not completely housed in the radial direction within those radial holes, but rather can protrude radially either outwardly or inwardly or both. The body 71 of the ball pusher assembly 70 has a close fit to the inner diameter of the latch sleeve 85 of the latch assembly 84, while the secondary spring recess 92 of the spring retainer 90 has a close fit to the outer diameter of the latch sleeve 85.

The male annular latch groove 72 of the ball pusher assembly 70 has a radial depth sufficient to permit the radially inwardly urged balls 86 of the latch assembly 84 to radially extend no farther than the outer diameter of the latch sleeve 85 when the groove 72 is coplanar with the holes of the latch sleeve. Likewise, the female annular groove 93 of the spring retainer 90 has a radial depth sufficient to permit the radially outwardly urged balls 86 mounted in the latch sleeve 85 to radially extend no farther than the inner diameter of the latch sleeve when the groove 93 is coplanar with the holes of the latch sleeve.

Whenever the latch balls 86 are engaged in the both the latch sleeve 85 and the annular latch groove 72 of the ball pusher 70 and held there by the radial reaction of the balls against the secondary spring recess 92, the application of axial forces on the ball pusher urges the balls radially outwardly. Likewise, whenever the latch balls 86 are engaged in the both the latch sleeve 85 and the annular latch groove 93 of the spring retainer 90 and held there by the radial reaction of the balls against the outer diameter of the ball pusher body 71, the application of axial forces on the latch sleeve urges the balls radially inwardly. The radial forces urging radial movement of the balls 86 result from the interaction of the balls with the frustroconical ends of the grooves 72, 93 whenever axial loadings are applied to the balls.

When the latch assembly 84 is coupled to the ball pusher 70, the bias forces of the secondary spring 97 are transmitted to the ball pusher by the balls 86 interacting both with the latch sleeve 85 and the annular groove 72 of the ball pusher 70. The balls 86 remain engaged with the ball pusher 70 in this situation due to radially inward reactions from secondary spring recess 92.

When the ball pusher 70, biased by the secondary spring 87 acting on the latch assembly 84, is being moved upwardly closer to the spring retainer 90, the balls 86 will tend to shift radially outwardly when they encounter the annular latch groove 93 of the spring retainer. When the balls 86 move close enough to the annular latch groove 93 in this situation, they will fully shift out of engagement with the groove 72 of the ball pusher assembly 70 and into full engagement with the groove 93. The ball pusher 70 is then fully decoupled from the latch assembly 84.

Further upward movement of the ball pusher 70 then causes the balls 86 to be trapped in their outward position in groove 93 by contact with the outer cylindrical wall of the ball pusher 70. When this condition exists, the ball pusher assembly 70 only transmits downward ball opening bias forces from the main spring 78 to the ball 53. Any biasing forces from the secondary spring 87 do not act on the ball 53 for this situation, since the latch assembly 84 is fully decoupled from the ball pusher 70 and coupled to the spring retainer 90.

When the ball pusher assembly 70, biased by only the main spring 78 acting on the spring washer 74 and snap ring 74 of the ball pusher assembly, is being moved downwardly farther from the spring retainer 90, the balls 86 of the latch assembly 84 will tend to shift radially inwardly when they encounter the annular latch groove 72 of the ball pusher. When the bails 86 move close enough to the annular latch groove 72 in this situation, they will fully shift out of engagement with the groove 93 of the spring retainer 90 and into full engagement with the groove 72. The ball pusher 70 is then fully recoupled to the latch sleeve 85.

Further downward movement of the ball pusher 70 causes the balls 86 to then be trapped in their inward position in groove 72 by contact with the inner cylindrical wall of the secondary spring recess 92 of the spring retainer 90. When this condition exists, the ball pusher assembly 70 transmits downward ball opening bias forces to the ball 53 from both the main spring 78 and the secondary spring 87.

As a consequence of this unlatching and relatching action of the secondary spring 87 biased latch assembly 84, the ball 53 is strongly biased against the ball stop 21 by both main spring 78 and secondary spring 87 when normal flow or no flow are passing from the fluid entry end to the fluid exit end of the valve 10. However, whenever the ball 53 is moved towards its main seat 62 more than a short distance, decoupling of the latch assembly 84 from the ball pusher assembly 70 reduces the opening bias forces on the ball to only those provided by the main spring 78.

Fluid induced forces also act on the ball 53 and the flappers 44. The flapper and seat assembly 34 is fixedly mounted in the ball 53 with O-ring 50 sealing between the ball and the flapper seat ring 35. The springs 46 urge the flappers 44 to their normally closed position but are easily overcome by minor flows from the inlet end of the valve 10. However, when there are no or reverse flow conditions for the valve, the flappers 44 are firmly biased against their seating surface 36. When the flappers 44 are fully closed, the combination of the ball 53 and the flappers 44 functions like a piston for reverse flow.

Of necessity, operating clearances have to exist between adjacent flappers when multiple flappers 44 are used. The use of multiple flappers to close the flow passage for the valve 10 permits a reduction in ball 53 size and hence body 11 size when compared to the case for use of a single flapper. For a valve newly in service, the resultant clearance gaps result in some flow past the closed flappers when reverse flow conditions exist, and the gaps can grow over time in abrasive flow conditions. However, the amount of reverse flow allowed by the flappers in any case is minor and flapper wear will require only a very small increase in reverse flow from the full flapper closure condition to produce sufficient force to bias the ball 53 to full closure against its seat 62.

Whenever the ball 53 moves a short distance away from its fully open condition abutted against the ball stop 21, the ball pusher seat 73 initially remains in sealing contact with the ball. However, additional ball rotation beyond a geometrically determined limit will break the seal between the ball and ball pusher seat 73. When that happens, an extraneous flow path is created through the clearance gap both between the ball 53 and main bore 14 of the body 11 and also between the ball pusher seat 73 and the ball 53. This extraneous flow path necessitates sufficient reverse flow induced pressure to overcome the spring biasing forces acting to attempt to hold the ball open. Normally, the increased flow in this case is minor.

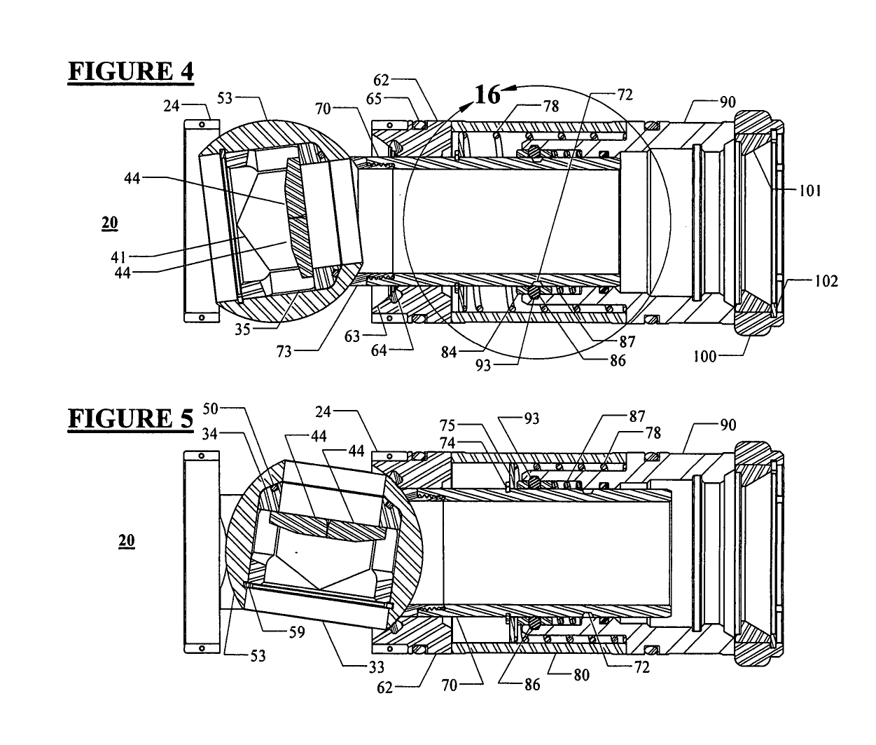

The outer and inner diameters of the ball pusher seat 73 are selected to ensure that, during ball 53 closing travel towards its main seat 62, the latch assembly 84 releases the ball pusher assembly 70 prior to loss of sealing contact between the ball pusher seat and the ball. FIG. 4 shows the ball 53 translated and rotated sufficiently in the closing direction from the lower ball stop 21 that the ball pusher seat 73 has only marginal sealing with the ball 53. However, the amount of upward travel seen in FIG. 4 of the ball 53 from the ball stop 21 is sufficient in this condition to have already decoupled the latch assembly 84 from the ball pusher 70, thereby removing the ball opening bias force of the secondary spring 87 from the ball.

FIG. 15 illustrates the variation in the opening bias force on the ball 53 as a function of the displacement of the ball from its fully open position resting against the ball stop 21. A relatively high force produced by reverse flow in the valve 10 is required to initiate valve movement sufficiently away from the ball stop 21 to decouple the biasing forces of the secondary spring 87 from biasing the ball towards its open position. However, once the bias of the secondary spring 87 is removed, the fluid induced closure forces needed to produce full ball closure against the main seat 62 are appreciably reduced. When the ball 53 is fully closed against the main seat 62, the flappers 44 are pressure balanced. In any case, the reverse flow induced forces needed to fully close the valve 10 can be provided with relatively low flows.

When normal flow from the inlet end of the valve 10 initiates with the valve in its closed position, the flow induced pressure on the ball 53 urges the ball towards its normally open condition against the ball stop 21. The opening bias forces on the ball 53 from the main spring 78 are always active, and the engagement of the balls 86 of the latch assembly 84 with the ball pusher 70 results in the additional opening bias force of the secondary spring 87 contributing to maintaining full opening of the ball.

### ADVANTAGES OF THE INVENTION

The improved self-piloted check valve of the present invention offers numerous benefits compared to conventional check valves. Because of its full opening construction, the valve has very low pressure losses, even with unusually high flow rates. The full opening construction also permits the unimpeded passage of objects through the bore of the valve when normal flow is occurring. This feature is useful in some service conditions. The low flow restriction is a result of minimal flow turbulence, which leads to a reduced tendency for wear from abrasive flows.

While the piloting flappers are always susceptible to abrasive and other types of fluid erosion, they do not have to fully seal when closed to pilot the valve. With the ball closed against its seat, the flappers are pressure balanced and inactive in preventing reverse flow. Only engagement of the ball and its seat prevent reverse flow. As the flappers wear, the reverse flow necessary to obtain ball valve closure increases, but the valve still functions.

The primary reason for the long life of the improved self-piloted check valve is the protection of both the spherical sealing surface of the ball and its seat from all flow except the low flows passing the ball and its seat during bidirectional shifting of the valve between its open and closed positions. These low bypass flows are sufficiently slow to not present and erosion problem.

When the improved self piloted check valve is used as either a inside blowout preventer or a float valve in a drillstring or as a drilling choke and kill manifold check valve, it is actually desirable that the flappers not be pressure tight. The inherent leakiness of the flapper valve utilized in the present invention permits the transmission of pressure downstream of the valve through the normally closed flappers and normally ball valve so that it can be measured by gauging means if all flow is temporarily prevented. This capability of pressure measurement through the improved self piloted check valve is critical in drilling applications.

Likewise, permitting some limited reverse flow through the open ball and closed but deliberately leaky valve flappers shown in FIG. 12 for the choke and kill manifold check valve is essential to allowing necessary fluid displacements from wireline operations through the valve while still having reliable closure for undesirably large reverse flows.

Provision of a two stage ball opening bias, such as that indicated in FIG. 15, is important for avoiding excessive ball motion whenever the valve is strongly vibrated, such as is the case for drilling float valves. If the contacts between the ball and its ball cage are subject to excessive vibration, such as can occur in near bit drilling applications of the float valve version of the valve, then the provision of a higher opening bias on the ball can substantially limit wear on the ball and its ball cage.

Having to overcome a higher ball opening spring bias is also desirable to ensure the development of sufficient force from reverse flow to ensure complete displacement of the ball from its open position to its sealing position abutting its seat. This is particularly advantageous when the valve is to be used in film forming fluids, such as crude oils with high paraffin contents. Also, isolating the exterior of the open ball from film forming fluids due to sealing of the ball pusher seat with the ball when the valve is open further minimizes the tendencies for the valve to stick partially open or closed due to film buildup. These and other advantages will be apparent to those skilled in the art.

The space between the main seat of the valve and the spring retainer is essentially isolated by the O-ring of the spring retainer. This permits the spring washer to provide damping for upward movement of the ball pusher and ball. As a result, component wear is reduced by this feature. Engaging the spring washer on both sides by snap rings can permit bidirectional damping. Bidirectional damping of ball motion is important to reduce wear in high vibration situations such as those encountered by float valves.

Various changes can be made to the construction of the improved self piloted check valve of the present invention without departing from the spirit of the invention. Different materials can be used for reasons of corrosion or temperature resistance. Different spring types can also be substituted for the coil springs, such as the use of a wave spring instead of the coil spring used for the secondary bias spring. A metal-to-metal seat can be substituted for the elastomeric ball seat seal. Minor changes can render the valve fire safe. These and other changes do not depart from the spirit of the invention.

What is claimed is:

1. A valve apparatus, comprising a valve body having a straight open fluid passage therethrough and containing:
(a) a main valve having a through flow passage and which is:
(i) movable within the valve body fluid passage in a first direction to a first position at which the main valve is open,
(ii) movable in a second direction opposed to the first direction to a second position within the valve body fluid passage at which the main valve is closed,
(iii) biased in the first direction toward the open position by a spring bias means,
(iv) movable to the second position at which the main valve is closed and at which the body fluid flow passage is closed in response to fluid flow in the valve body imposing fluid pressure against the main valve in the second direction,
(b) a pilot valve for closing the fluid flow passage of the main valve in response to fluid flow imposing fluid pressure acting in the second direction, thereby enabling the main valve to close when fluid pressure against the main valve is in said second direction, the pilot valve when open having a fully open flow passage in line with and at least as large as the fluid flow passage of the main valve means, and
(c) a spring bias means provided by a combination of a first spring continuously active in providing bias and a second spring active only between the first position and a third position intermediate between the first and second positions of the main valve.

2. The valve apparatus of claim 1, the pilot valve comprising a check valve.

3. The valve apparatus of claim 2, the check valve being biased to close whereby the check valve is closed when there is no fluid flow through the valve apparatus and when the fluid flow is in said second direction.

4. The valve apparatus of claim 1, wherein the bias of the main valve toward its open position has a magnitude such that the main valve is closed by fluid pressure acting against the main valve in the second direction even though there is fluid leakage past the pilot valve in its closed condition.

5. The valve apparatus of claim 4, including a valve body having:
(a) a fluid flow opening therethrough,
(b) a support stationarily supported in the flow opening for supporting the main valve in the flow opening for movement between the main valve open and closed positions,
(c) a sleeve providing said bias and lining said flow opening and bearing against the side of said main valve from said first direction to conduct fluid flow thereto, wherein the second spring is coupled to the sleeve by a trigger means, wherein said trigger means is:
(i) separable from said sleeve when moving in said second direction a first fixed distance from said first position and
(ii) engagable with said sleeve when moving in said first direction a second fixed distance.

6. A valve apparatus, comprising:
(a) a main valve having a fluid flow passage therethrough, wherein the main valve is biased in a first direction toward an open position by a bias means and movable in an opposed second direction to a closed position against a seat in response to fluid flow imposing fluid pressure against the main valve in the second direction when main valve fluid flow passage is closed,
(b) a pilot valve for closing the main valve fluid flow passage in response to fluid flow imposing fluid pressure in the second direction to enable the main valve to close when fluid pressure against it is in the second direction, the bias of the main valve in the first direction being of a magnitude such that the main valve is closed by fluid pressure against it in the second direction even though there is fluid leakage past the pilot valve in its closed condition,
(c) a valve body having a fluid flow opening therethrough,
(d) a ball cage stationarily supported in the valve body flow opening for supporting the main valve in the body flow opening for movement between its open and closed positions,
(e) a bias means consisting of a combination of a first spring continuously active in providing bias and a second spring active only between the first position and a third position intermediate between the first and second positions,
(f) a sleeve lining a portion of the valve body flow opening and bearing against the main valve to apply bias forces from the bias means to the main valve, wherein the sleeve:
(i) applies bias to the main valve at its open and closed positions and therebetween and
(ii) conducts fluid to the main valve with the main valve in its open position,
(g) a main seat positioned disposed around the sleeve against which the main valve seats at a seating area thereof transverse to the body flow passage,
wherein the main valve comprises a spherically formed valve ball pivotally connected eccentrically to the ball cage and adapted to be pivotably moved between its open first position wherein its flow passage is aligned with the body flow opening and the main valve closed second position wherein the main valve flow passage is not in fluid communication with the valve body flow opening, and the main seat has a spherical seating area.

7. The valve apparatus claim 6, including elastomeric sealing means around the ball seat to prevent fluid flow past the ball seat when the valve ball is seated in its closed position against the ball seat.

8. The valve apparatus of claim 7, the pilot valve being disposed to close a transverse passage through the valve ball, wherein the pilot valve is a check valve having a closure means constituted of multiple flapper segments biased to close, whereby:
(a) the pilot check valve is closed when there is no fluid flow through the valve apparatus and when the fluid flow is in the second direction and
(b) the pilot check valve is opened when there is flow in the first direction.

9. The valve apparatus of claim 8, wherein the sleeve lining a portion of the body and biasing the ball forms a shield to prevent fluid erosion of the ball seat and the valve ball when the valve ball is in its open position.

10. The valve apparatus of claim 9, wherein a spring retainer, disposed circumferentially of the sleeve bearing on the main valve, is retained within the valve body and serves as a first abutment against which the bias means reacts.
